(19) United States
(12) Patent Application Publication
(10) Pub. No.: US 2024/0097186 A1
(43) Pub. Date: Mar. 21, 2024

(54) HIGH-PERFORMANCE CERAMIC-POLYMER SEPARATORS FOR LITHIUM BATTERIES

(71) Applicant: University of Dayton, Dayton, OH (US)

(72) Inventors: Jitendra Kumar, Dayton, OH (US); Guru Subramanyam, Dayton, OH (US)

(21) Appl. No.: 18/300,856

(22) Filed: Apr. 14, 2023

Related U.S. Application Data
(63) Continuation of application No. 17/558,982, filed on Dec. 22, 2021, now abandoned.
Application No. 17/558,982 is a continuation of application No. 16/831,090, filed on Mar. 26, 2020, now abandoned.
Application No. 16/831,090 is a continuation of application No. 15/655,492, filed on Jul. 20, 2017, now abandoned.
(60) Provisional application No. 62/364,609, filed on Jul. 20, 2016.

(51) Int. Cl. H01M 10/0565; H01M 4/38; H01M 4/525; H01M 10/052; H01M 10/0525; H01M 10/056; H01M 10/0562; H01M 50/403; H01M 50/417; H01M 50/423; H01M 50/434; H01M 50/457

(52) U.S. Cl. CPC H01M 10/0565; H01M 4/38; H01M 4/382; H01M 4/525; H01M 10/052; H01M 10/0525; H01M 10/056; H01M 10/0562; H01M 50/403; H01M 50/417; H01M 50/423; H01M 50/434; H01M 50/457; H01M 2300/0068; H01M 2300/0082; H01M 2300/0094; Y02T 10/70

(57) ABSTRACT

An EB-PVD technique was used to fabricate ceramic/polymer/ceramic (LAGP/PE/LAGP) hybrid separator for rechargeable LIBs and Li batteries. The application of a ceramic electrolyte (LAGP) layer on traditional PE separator soaked in 1-M LiAsF₆ liquid electrolyte combined the best attributes of traditional PE separator and solid inorganic electrolytes. The synergistic behavior of hybrid separator resulted in a high mechanical stability/flexibility, increased liquid uptake, high ion conduction, reduced cell voltage polarization, no lithium dendrite formation, and increased usable lithium content as compared to the state-of-the-art PE separator used in LIBs. The functional separator can be used to prolong life cycle and power capability of present LIBs. Thickness and density optimization of LAGP or similar electrolytes on polymer or other battery separators and their use in full Li battery (LIB, Li—S, Li—O₂, Li-Ph, flow battery) cells are expected to further improve performance.

### CROSS-REFERENCES TO RELATED APPLICATIONS

This application is a continuation of U.S. patent application Ser. No. 17/558,982, filed Dec. 22, 2021, which is a continuation of U.S. patent application Ser. No. 16/831,090, filed Mar. 26, 2020, now abandoned, which is a continuation of U.S. patent application Ser. No. 15/655,492, filed Jul. 20, 2017, now abandoned, which claims the benefit of priority under 35 U.S.C. § 119(e) to U.S. Provisional Application Ser. No. 62/364,609, filed Jul. 20, 2016.

### TECHNICAL FIELD

The present disclosure relates to lithium batteries and, more particularly, to ceramic electrolyte-polymer separators for lithium batteries and lithium batteries containing the separators.

### BACKGROUND

Lithium-ion batteries (LIBs) having high energy density, power density, long cycle life, as well as low memory effect (hysteresis), are widely used in various applications ranging from consumer electronics to automobiles. Even though LIBs have transformed the electronics industry, the energy density, power density, cycle life and safety are inadequate for higher-energy applications, such as batteries for all-electric vehicles, aircraft batteries, or batteries that can power heavy machinery or extend the working hours of the current batteries.

LIBs include a lithium transition metal oxide cathode and carbonaceous anode, whereas Li batteries (Li—S, Li—O₂, and advanced LIBs) use Li metal as common anode and S, O₂, or transition-metal oxides as cathode separated by a membrane containing a non-aqueous liquid electrolyte or solid/gel electrolytes. Solid/gel electrolytes perform both as separator and electrolyte. Functioning of LIBs involves reversible lithium extraction from transition metal oxide host as the rechargeable cathode and into graphite as the anode host. Whereas functioning of Li batteries involves reversible extraction of lithium from lithium metal anode and into S, O₂ or transition metal oxide cathode. Micro-porous polyolefin separators, such as PE and polypropylene (PP) are commonly used in LIBs or Li batteries involving non-aqueous liquid electrolyte. The separator is a key component of LIBs or liquid-based Li batteries, and serves as a physical membrane that allows the transport of Li ions, but prevents direct contact between cathode and anodes.

Efforts have been made to improve separator performance (especially for liquid electrolyte-based LIBs) by solution coating of inorganics (for example, Al₂O₃, MMT, SiO₂), along with binders on polymer separators (for example, PE, PP) or by fabricating nanostructured polymer-/copolymer-inorganic mix utilizing various techniques, such as electrospinning or fabricating alumina- or alumina/phenolphthalein polyetherketone-based, porous ceramic membranes. Electrospun fibrous composites of Li⁺ ion conducting inorganics (lithium lanthanum titanate oxide) with polyacrylonitrile (PAN) show higher liquid uptake, higher ion conductivity, higher electrochemical stability and overall improvement on cell performance. Solid electrolytes based on polymer, ceramic, and polymer-ceramic composites have proven to be promising as separators as well as electrolytes for batteries beyond LIB. Polymer and gel electrolytes can be fabricated in thin film form, dendrite growth is difficult to prevent completely. In addition to high Li⁺ ion conductivity, ceramic solid electrolytes such as LAGP (5 mS/cm at 23° C.) or lithium aluminum titanium phosphate (LATP) (3 mS/cm at 25° C.) combines many favorable properties. Their solid-state nature, broad electrochemical potential (>5 V), negligible porosity, and single-ion conduction (high transference number, no dendrite formation, no crossover of electrode materials to opposite side of electrodes compartment, etc.) enable high-energy battery chemistries and mitigating safety and packaging issues of conventional lithium batteries.

### SUMMARY

A three-layered (ceramic electrolyte-polymer-ceramic electrolyte) hybrid electrolyte/separator was prepared by coating ceramic electrolyte [lithium aluminum germanium phosphate (LAGP)] over both sides of polyethylene (PE) polymer membrane using electron beam physical vapor deposition (EB-PVD) technique. Ionic conductivities of membranes were evaluated after soaking PE and LAGP/PE/LAGP membranes in a 1-Molar (1-M) lithium hexafluroarsenate (LiAsF₆) electrolyte in ethylene carbonate (EC), dimethyl carbonate (DMC) and ethylmethyl carbonate (EMC) in volume ratio (1:1:1). Scanning electron microscopy (SEM) and X-ray diffraction (XRD) techniques were employed to evaluate morphology and structure of the separators before and after cycling performance tests to better understand structure-property correlation. As compared to regular PE separator, LAGP/PE/LAGP hybrid separator showed: (i) higher liquid electrolyte uptake, (ii) higher ionic conductivity, (iii) lower interfacial resistance with lithium, (iv) improved thermal (safety) stability of the battery, and (v) lower cell voltage polarization during lithium cycling at high current density of 1.3 mA·cm⁻² at room temperature.

The enhanced performance is attributed to higher liquid uptake, LAGP-assisted faster ion conduction, and dendrite prevention. Optimization of density and thickness of LAGP (or other metal ion ceramic conductors family such as LiSICON, LiPON, Perovskite, garnet-type, phthalocyanine, etc.) layers on PE or other membranes (such as glass membranes, imide/amide based membrane, etc.) through manipulation of physical-vapor deposition (PVD) or atomic layer deposition (ALD) or sputtering or laser ablation process parameters will enable practical applications of this hybrid separator in rechargeable lithium batteries with high energy, high power, longer cycle life, and higher safety level.

Additional features and advantages of the embodiments described herein will be set forth in the detailed description which follows, and in part will be readily apparent to those skilled in the art from that description or recognized by practicing the embodiments described herein, including the detailed description which follows, the claims, as well as the appended drawings.

It is to be understood that both the foregoing general description and the following detailed description describe various embodiments and are intended to provide an overview or framework for understanding the nature and character of the claimed subject matter. The accompanying drawings are included to provide a further understanding of the various embodiments, and are incorporated into and constitute a part of this specification. The drawings illustrate the various embodiments described herein, and together with the description serve to explain the principles and operations of the claimed subject matter.

### BRIEF DESCRIPTION OF THE DRAWINGS

FIG. 1 is a schematic cross-section of a lithium battery according to embodiments of this disclosure.

FIG. 2A shows electro-impedance spectra of PE and LAGP/PE/LAGP soaked in 1-M LiAsF₆/EC-DMC-EMC electrolyte at 23° C. Specifically, the electrochemical impedance spectra are at (a) 23° C. and (b) 85° C.

FIG. 2B shows electro-impedance spectra of PE and LAGP/PE/LAGP soaked in 1-M LiAsF₆/EC-DMC-EMC electrolyte at 85° C.

FIG. 2C shows ionic conductivities of PE and LAGP/PE/LAGP soaked in 1-M LiAsF₆/EC-DMC-EMC electrolyte in a temperature range of 23° C. to 85° C.

FIG. 3 includes SEM images of (a) a PE separator; (b) an LAGP-coated (130 nm) PE separator; and (c) 300th cycle cell polarization data of Li/Li symmetrical cells during Li plating-stripping at a current density of 1.3 mA·cm⁻², for the PE separator and the LAGP-coated flexible separator in an electrolyte. Both PE and LAGP/PE separators were soaked in 1-M LiAsF₆ electrolyte and sandwiched between two Li foils for fabricating Li/Li half cells.

FIG. 4A illustrates electrochemical impedance spectra of Li/Li symmetric cells using PE and LAGP/PE/LAGP hybrid separator soaked in 1-M LiAsF₆ liquid electrolyte before Li plating-stripping.

FIG. 4B illustrates electrochemical impedance spectra of Li/Li symmetric cells using PE and LAGP/PE/LAGP hybrid separator soaked in 1-M LiAsF₆ liquid electrolyte after the 300th Li plating-stripping at 23° C.

FIG. 5A is an SEM micrograph showing surface morphology of a PE separator after 300 cycles in a Li/Li symmetrical cell involving 1-M LiAsF₆ liquid electrolyte.

FIG. 5B is an SEM micrograph showing surface morphology of a LAGP/PE/LAGP separator after 300 cycles in a Li/Li symmetrical cell involving 1-M LiAsF₆ liquid electrolyte.

FIG. 5C is a stacked XRD pattern of various separators for lithium batteries according to embodiments of this disclosure.

FIG. 6 is a schematic of a micro combustion calorimeter and pyrolysis combustion flow calorimeter system.

FIG. 7 is a photograph of LAGP samples after heating at 800° C.

FIG. 8A is a graph of heat release rate for PE separator samples.

FIG. 8B is a picture of a final char for a PE separator.

FIG. 9A is a graph of heat release rate for LAGP+PE separator sample.

FIG. 9B is a picture of a final char for LAGP+PE separator.

FIG. 10 is a graph showing the first cycle charge and discharge characteristics of a full-cell Li-ion battery cell using an LAGP-coated PE separator in an electrolyte of 1M LiPF₆|EC:DMC:EMC (1:1:1=v:v:v).

FIG. 11A is a graph of Li—S battery capacity at 0.05 C rate and 0.2 C rate for an Li—S cell including an LAGP-coated PE separator in an electrolyte of 1 M LiTFSI|0.1 M LiNO₃|DOL:DME (1:1=v:v). With regard to C rate, it is noted that 1 C=1675 mAh/g.

FIG. 11B is a graph of cycling of Li—S at 0.2 C rate along with Coulombic efficiency (%) for an Li—S cell including an LAGP-coated PE separator and 1 M LiTFSI10.1 M LiNO₃|DOL:DME (1:1=v:v).

### DETAILED DESCRIPTION

Embodiments of the present disclosure are directed to a hybrid electrolyte/separator for lithium batteries, to lithium-ion batteries including the hybrid electrolyte/separator, and to methods for preparing lithium-ion batteries including the hybrid electrolyte separator.

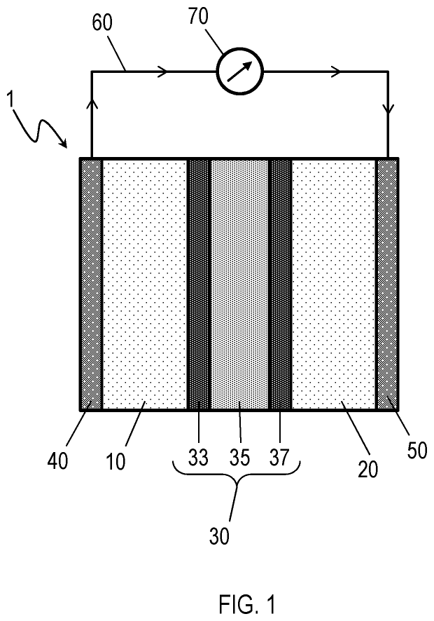

Referring to FIG. 1, a lithium-ion battery 1 includes an anode 10, a cathode 20, and a hybrid electrolyte separator 30 disposed between the anode 10 and the cathode 20. The hybrid electrolyte separator 30 includes a polymer membrane 35, a first ceramic coating 33 between the polymer membrane 35 and the anode 10, and a second ceramic coating 37 between the polymer membrane 35 and the cathode 20.

The anode 10 of the lithium-ion battery 1 may be any anode material suitable for use in lithium-ion batteries. For example, the anode 10 may include lithium metal or a lithium alloy. The cathode 20 of the lithium-ion battery 1 may be any cathode material suitable for use in lithium ion batteries. For example, the cathode 20 may be an oxide such as lithium cobalt oxide (LiCoO₂), lithium aluminum germanium phosphate (LAGP), lithium aluminum titanium phosphate (LATP). In some embodiments the cathode 20 may contain sulfur, such that the lithium-ion battery functions as a lithium-sulfur (Li—S) cell. In an example Li—S cell, the cathode may contain sulfur, LAGP, carbon nanotubes, a poly(vinylidene fluoride) (PVDF), or combinations thereof. Optionally, the lithium-ion battery 1 may further include an anode collector 40 electrically coupled to the anode 10, a cathode collector 50 electrically coupled to the cathode 20, or both. Examples of suitable materials for the anode collector 40 include aluminum. Examples of suitable materials for the cathode collector 50 include copper. Thus, the embodiment of the lithium-ion battery 1 of FIG. 1 may be connected to an external circuit 60 containing a load 70, so as to provide power to the external circuit 60 as electrons flow from the anode collector 40 to the cathode collector 50.

The hybrid electrolyte separator 30 includes a polymer membrane 35, a first ceramic coating 33 between the polymer membrane 35 and the anode 10, and a second ceramic coating 37 between the polymer membrane 35 and the cathode 20. In some embodiments the first ceramic coating 33 may be deposited or grown directly onto a first surface of the polymer membrane 35 and the second ceramic coating 37 may be deposited or grown directly onto a second surface of the polymer membrane 35 opposite the first surface. Suitable materials for the polymer membrane 35 include, for example, polyethylene, polyimides, or polyamides. Suitable materials for the first ceramic coating 33 and the second ceramic coating 37 include, for example, lithium-ion conductive materials such as lithium aluminum germanium phosphate (LAGP), lithium aluminum titanium phosphate (LATP), LiSICON, LiPON, perovskites, garnet-type ceramics, phthalocyanines, or combinations of these. In some embodiments, the first ceramic coating 33 and the second ceramic coating 37 are the same material or combination of materials. In some embodiments, the first ceramic coating 33 and the second ceramic coating 37 are different materials or different combinations of materials. In embodiments, the lithium-ion battery 1 may be configured as a Li-oxygen (Li—O₂) cell, a Li-Phthalocyanine (Li-Ph) cell, a redox flow battery, a supercapacitor, or a hybrid battery-capacitor.

In one example embodiment, the anode 10 of the lithium-ion battery 1 is lithium or a lithium alloy, the cathode 20 is LiCo₂, the polymer membrane is polyethylene, and both the first ceramic coating 33 and the second ceramic coating 37 are or contain LAGP. One specific LAGP material that has been found suitable as a ceramic coating on the polymer membrane of the hybrid electrolyte separator 30 has the empirical formula 19.75 Li₂O·6.17 Al₂O₃·37.04 GeO₂·37.04 P₂O₅.

In some embodiments of the lithium-ion battery 1, the anode 10, the cathode 20, and the hybrid electrolyte separator 30 may be disposed in a liquid electrolyte. Suitable liquid electrolytes in this regard include any known liquid electrolyte or liquid electrolyte mixture electrochemically compatible with lithium-ion batteries. Examples of such suitable liquid electrolytes include LiPF₆ in a solvent system that may include ethylene carbonate, dimethyl carbonate, ethylmethyl carbonate or mixtures thereof.

Having described the lithium-ion battery 1 according to various embodiments, further embodiments are directed to methods for preparing the lithium-ion batteries. Methods for preparing a lithium-ion battery 1 may include depositing a first ceramic coating 33 onto a first surface of a polymer membrane 35 and depositing a second ceramic coating 37 onto a second surface of the polymer membrane 35 opposite the first surface. In some embodiments, the two depositions may occur simultaneously. In some embodiments, the two depositions may occur in separate steps that may include removing the polymer membrane 35, coated on a single side with the first ceramic coating 33, from a deposition chamber then, subsequently performing a second coating step of the second ceramic coating 37 onto the side of the polymer membrane 35 opposite the first ceramic coating 33.

The deposition steps of the methods for preparing the lithium-ion battery 1 may include any suitable deposition technique for forming ceramic coatings, layers, or films. For example, the first ceramic coating 33 and the second ceramic coating 37 may be deposited by electron-beam physical vapor deposition, atomic layer deposition, sputtering, laser ablation, chemical vapor deposition, or combinations thereof. The first ceramic coating 33 and the second ceramic coating 37 may be deposited by the same process or by different processes. In some embodiments, the first ceramic coating 33 and the second ceramic coating 37 both are deposited by electron-beam physical vapor deposition.

After the hybrid electrolyte separator 30, including the polymer membrane 35, the first ceramic coating 33, and the second ceramic coating 37, is prepared, the lithium-ion battery 1 may be assembled. In embodiments, assembling the lithium-ion battery 1 may include assembling the polymer membrane 35 coated with the first ceramic coating 33 and the second ceramic coating 37 between an anode 10 and a cathode 20 such that the first ceramic coating 33 faces the anode 10 and the second ceramic coating 37 faces the cathode 20. The anode 10 may be lithium or a lithium alloy. The cathode 20 may be any suitable cathode material such as LiCoO₂ or a sulfur-containing cathode, for example. A sulfur-containing cathode may include sulfur and, in addition, LAGP, carbon nanotubes, PVDF, or combinations thereof.

As in the embodiments of the lithium-ion battery previously described, in the methods for preparing the lithium-ion battery, the polymer membrane 35 may be chosen from polyethylene, polyimides, or polyamides. Likewise, the first ceramic coating 33 and the second ceramic coating 37 may be lithium-ion conductive materials independently chosen from lithium aluminum germanium phosphate (LAGP), LiSICON, LiPON, lithium aluminum titanium phosphate (LATP), perovskites, garnet-type ceramics, or phthalocyanines. In some embodiments, the polymer membrane 35 is or includes polyethylene and the first ceramic coating 33 and the second ceramic coating 37 is or includes a lithium aluminum germanium phosphate (LAGP) such as 19.75 Li₂O·6.17 Al₂O₃·37.04 GeO₂·37.04 P₂O₅, for example.

In some embodiments, the first ceramic coating 33 and the second ceramic coating 37 may be deposited directly onto opposing surfaces of the polymer membrane 35 by any suitable process such as, for example, electron-beam physical vapor deposition.

Further embodiments may be directed to hybrid electrolyte separators suitable for use in a lithium-ion battery. A hybrid electrolyte separator may include a polymer membrane, a first ceramic coating on a first surface of the polymer membrane, and a second ceramic coating on a second surface of the polymer membrane opposite the first surface. The polymer membrane may be chosen from polyethylene, polyimides, or polyamides. The first ceramic coating and the second ceramic coating may be lithium-ion conductive materials independently chosen from lithium aluminum germanium phosphate (LAGP), LiSICON, LiPON, perovskites, garnet-type ceramics, or phthalocyanines. In an example embodiment of such a hybrid electrolyte separator, the polymer membrane may be polyethylene and at least one of the first ceramic coating and the second ceramic coating is or contains lithium aluminum germanium phosphate (LAGP). In a further example embodiment of such a hybrid electrolyte separator, the polymer membrane may be polyethylene and both the first ceramic coating and the second ceramic coating are or contain lithium aluminum germanium phosphate (LAGP).

### Examples

The following examples illustrate one or more additional features of the present disclosure described previously. It should be understood that these examples are not intended to limit the scope of the disclosure or the appended claims in any manner.

Ultrathin layers (approximately 130 nm) of supertonic conducting ceramic (LAGP) were deposited on both sides of PE separator by using an electron-beam physical vapor deposition (EB PVD) technique. LAGP solid ceramic electrolytes having high ion conductivity were used as the single Li⁺-ion conducting ceramic to stop dendrite formation and growth during Li cycling. Characterization data for the separator show that coating of LAGP onto a PE membrane can combine the properties of both components (PE and LAGP) and lead to a hybrid separator that has high mechanical strength, large liquid electrolyte uptake, high ionic conductivity, good electrochemical stability, improved safety, reduced electrode-electrolyte interface resistance and low Li stripping/plating voltage polarization.

As a result, the hybrid membranes including LAGP/PE/LAGP electrolytes or other ceramic electrolytes can provide suitable structures and properties for separating electrodes, supporting electrolytes, and transporting lithium ions. Lithium-ion cells using these membrane separators may achieve good battery performance, such as large capacity, good cycleability, high-rate capability, and enhanced safety.

### Preparation of Hybrid Membrane

LAGP target material for fabricating hybrid membranes was prepared following the procedure disclosed in Kumar et al., J. Electrochem. Soc., vol. 156 (2009) beginning at page A506, the full article of which is incorporated herein by reference in its entirety.

First, LAGP glass having a molar composition 19.75 Li₂O·6.17 Al₂O₃·37.04 GeO₂·37.04 P₂O₅ was synthesized through solid-melt reaction at 1350° C. by using reagent grade chemicals such as Li₂CO₃ (Alfa Aesar), Al₂O₃ (Aldrich), GeO₂ (Alfa Aesar), and NH₄H₂PO₄ (Acros Organics). The chemicals were weighed, mixed, and ground for 10 min with an agate mortar and pestle. For further homogenization, the batch was milled in a glass jar for 1 h using a roller mill. The milled batch was contained in a platinum crucible and transferred to an electric furnace. Initially, the furnace was heated to 350° C. at the rate of 1° C./min and held at that temperature for 1 h to release the volatile components of the batch before raising the furnace temperature to 1350° C. at the rate of 1° C./min after which the glass was melted for 2 h. A clear, homogeneous, viscous melt was poured onto a stainless steel (SS) plate at room temperature and pressed by another SS plate to yield transparent glass sheets less than 1 mm thick. Subsequently, the cast and pressed glass sheets were annealed at 500° C. for 2 h to release thermal stresses and were then allowed to cool to room temperature. These annealed specimens remained in the glassy state as noted by visual observation.

Subsequently, LAGP glass was crystallized at 850° C. for 12 h, (hereafter, “LAGP ceramic”) for developing a 3D ion conducting structure. The measured bulk ion conductivity of this LAGP composition was found to be approximately 5 mS·cm⁻¹ at room temperature.

Even though the ionic conductivity of LAGP is high, it cannot be used as an electrolyte with energy-dense Li metal anode. This is because of the high level of chemical reactivity of LAGP, similar to other LiSICON ceramic electrolytes, when in direct contact with Li metal. A possible solution to this chemical reactivity issue is to put a thin stable film at the Li/LAGP interface such as, for example a LiPON-coated LATP plate that is chemically stable against Li metal, or a lithium oxide/boron nitride based polymer-ceramic composite to stabilize the Li/LAGP interface. In the present disclosure, liquid electrolyte (LiAsF₆ in EC:EMC:DMC) including 2 wt. % vinylene carbonate (VC) has been used as the interface layer between Li and LAGP to stabilize the Li/LAGP interface. The use of VC for the lithium-metal anode suppresses the deleterious reaction between the deposited lithium (during lithium cycling) and the electrolyte.

A 130-nm thick LAGP film was deposited on both sides of a PE separator (Celgard, MTI Corp.) using EB-PVD. The EB-PVD system has a multi-hearth high power electron beam source capable of evaporating most metals and ceramics at a fast rate. In this process, electrolyte material (LAGP) was placed in a graphite crucible.

The cleaned substrate (PE) was mounted on a metal plate. The chamber was evacuated to a base pressure of <10⁻⁶ Torr. A deposition rate of 1.0 nm/s or 1.5 nm/s was used to deposit an approximately 130-nm thick LAGP film on one side of the PE separator and then on the other side. The deposition parameters can be manipulated to obtain an LAGP film of a desired thickness, density, or porosity. The as-prepared LAGP/PE/LAGP functional separator was used for the current investigation without further treatment.

The flexibility of LAGP/PE/LAGP separator was similar to that of the PE separator. A separator in the form of a disc was punched out and used in the present investigation. Punching the separator may damage the edges, and there may be risk of a potential short circuit. Keeping this possibility in mind, a larger sized separator compared to electrodes (Li or SS) was used to avoid short-circuit risks that may arise from damaged separator edges. The diameter of separator and electrode used were 17 mm and 16 mm, respectively.

### Characterization of Hybrid Membrane

Coin cells were fabricated to determine electrochemical impedance spectra of PE and hybrid (LAGP/PE/LAGP) separators using stainless steel (SS) electrodes (SS/separator-1-M LiAsF₆/EC-DMC-EMC/SS). In addition, coin cells were fabricated using pure lithium metal as electrodes to determine Li plating and stripping (Li/separator-1-M LiAsF₆/EC-DMC-EMC/Li). The liquid electrolyte used in the present investigation includes 2% vinylene carbonate (VC). Coin cells were assembled in an ultra-pure glove box (O₂, H₂O<1 ppm) (Pure LabHE Innovative Technology, Industrial Way, Amesbury, MA 01913).

Electrical and electrochemical performances of cells were evaluated using a Solartron SI 1287 electrochemical analyzer in conjunction with an SI 1260 impedance/gain-phase analyzer. Electrochemical impedance spectroscopy (EIS) of the cells was conducted over a frequency range 0.1 Hz to 10⁶ Hz. Li stripping-plating measurements on Li/Li symmetrical cells were performed in a galvanostatic mode with a constant current density 1.3 mA·cm⁻².

Surface morphologies of PE and hybrid separator were examined using SEM. The XRD patterns were collected at angles 15°<20<80° on (Rigaku D/MAX) fitted with CuKα radiation source.

### Discussion

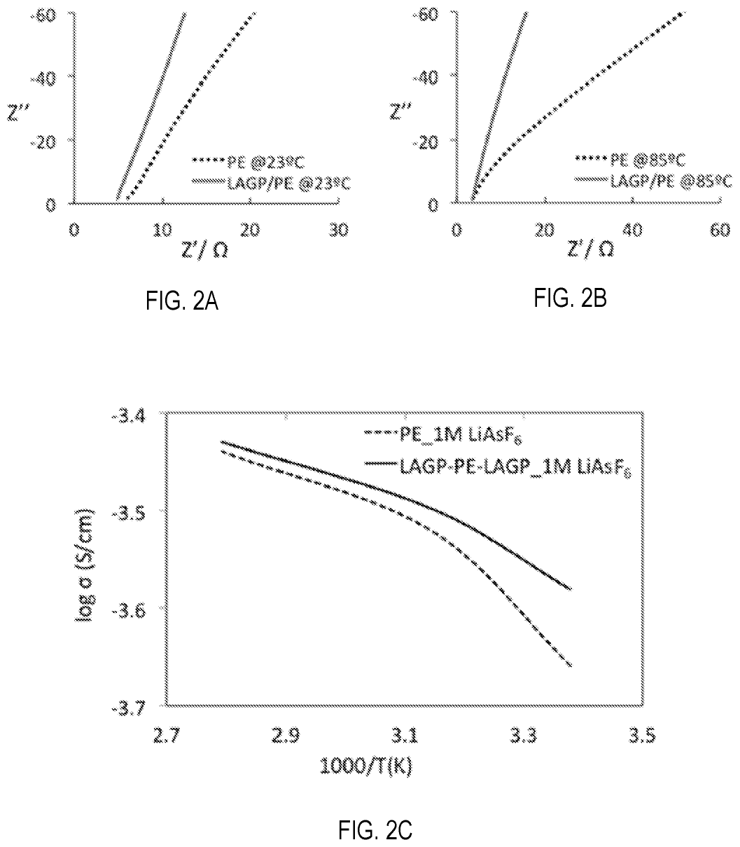

FIGS. 2A and 2B are impedance plots at 23° C. (FIG. 2A); and at 85° C. (FIG. 2B). FIG. 2C is an Arrhenius plot of PE and LAGP/PE/LAGP separators in 1-M LiAsF₆/EC-DMC-EMC electrolyte. The diameters of separators and SS electrodes were 1.7 cm and 1.6 cm, respectively. The size of the separator was larger than the size of SS electrodes to avoid any electrical shorting and eliminating potential debris produced damage during separator cutting. A common active area between separator and SS electrodes equal to 2 cm 2 was considered for conductivity measurement. The high frequency Z′ intercept (FIGS. 2A and 2B) was used as the bulk electrolyte impedance. The value of impedance (in Ω) was normalized with samples common area (A=2 cm 2) and thickness of separators (Celgard t=25 μm; LAGP/PE/LAGP t=25 μm+130×2 nm (thickness of LAGP coating)) to calculate conductivity (σ=(t/A)×(1/impedance)). Before impedance measurement testing, samples were stabilized at various temperatures including 23° C. using an environmental chamber for 1 h.

The hybrid separator shows lower impedance compared to PE separator (FIGS. 2A and 2B). The hybrid separator (LAGP/PE/LAGP) exhibits increased ionic conductivity in the entire temperature range (23° C. to 85° C.) (FIG. 2C). The decrease in impedance and increase in ionic conductivity in the functional separator can be attributed to higher electrolyte uptake (EU) (approximately 20 wt. %) and added ionic contribution from LAGP component of the hybrid separator. The EU was calculated by the formula: EU (%)=((W_{f}−W₀)/W₀)×100, where W_{f} and W₀ are the weights of the electrolyte-soaked and dry membrane separators, respectively. Owing to the inorganic nature, the wettability of the polar liquid electrolyte (LiAsF₆/EC-DMC-EMC) with LAGP is expected to be higher than that of the non-polar PE separator.

When a drop of liquid electrolyte was introduced each on PE and LAGP/PE/LAGP separators, spreading and absorption of liquid was much faster in LAGP/PE/LAGP as compared to PE separator.

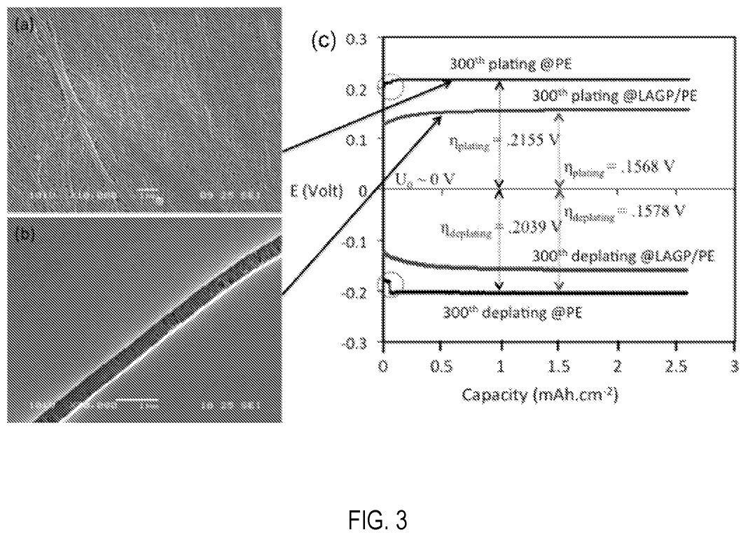

A practical ceramic solid electrolyte (e.g., LAGP, LASnP, LASiP, LATP) would be a few microns thick, but dense enough to mechanically stop dendrite growth. The goal of this effort was to demonstrate a workable concept of using binder free thin, dense, pristine, single Li⁺-ion conducting LAGP layers on flexible structures and demonstrate improved electrochemical performance compared to the traditional PE or PP separators. Coin-type symmetric Li|Li cells with hybrid membrane and PE membrane soaked in LiAsF₆ electrolyte were fabricated to investigate dynamic (Li plating and deplating process) electrochemical stability of both these membranes. FIGS. 3A and 3B show SEM images of PE and LAGP coated PE membranes respectively. FIG. 3C shows typical voltage profiles for the symmetric cell cycled in 1-M LiAsF₆ electrolyte.

The hybrid membrane as highly stable in 1-M LiAsF₆ for more than 300 cycles at a current density of 1.3 mA·cm⁻² with a high Li areal capacity (approximately 3 mAh·cm⁻²) during both Li plating and deplating processes. PE without LAGP coating not only leads to abrupt variation (red dotted circles) in polarization during initial Li plating and stripping, but also showed significant increase in voltage polarization as illustrated in FIG. 3C.

FIG. 3C shows significant lowering in Li/electrolyte-separator/Li symmetrical cell polarization after 300 cycles when LAGP film was deposited on both sides of reference polymeric separator (FIG. 3A). Low cell polarization is required for energy delivery for a cell operating at high charge-discharge rate.

FIGS. 3A and 3B show the high magnification SEM images of the porous PE membrane and the LAGP/PE/LAGP hybrid membrane. The PE membrane has a uniformly interconnected highly porous structure (FIG. 3A) and is responsible for free dendrite growth and penetration. For the hybrid membrane, a uniform and dense coating of LAGP on the porous PE membrane is evident in FIG. 3B that prevents growth of dendrites. The hybrid separator was used without any thermal treatment and few cracks were found. Post deposition annealing could potentially eliminate crack formation. However, high temperature annealing/sintering to make single-phase LAGP may require a separator material other than PE or PP (such as high temperature carbon fiber or glass fiber).

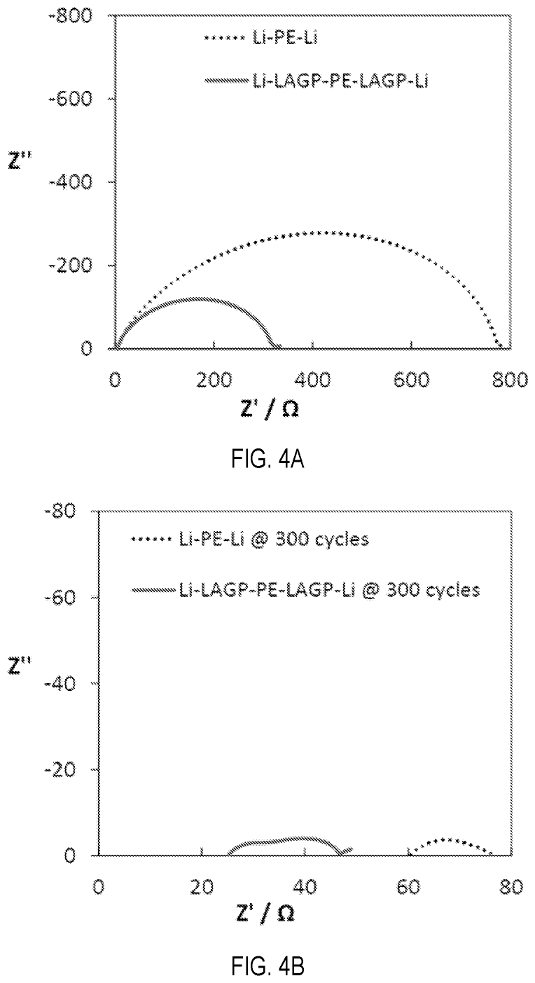

To understand the different electrochemical behavior observed in FIG. 3C, the impedance of the cells (involving PE and hybrid separator) before and after Li plating and deplating were measured and are shown in FIGS. 4A and 4B. Both before Li/Li cycling (FIG. 4A) and after Li/Li cycling (FIG. 4B), the LAGP-coated PE separator showed significantly lower cell resistance (electrolyte and charge transfer resistance). The higher ionic conductivity shown in FIG. 2C and lower cell impedance shown in FIGS. 4A and 4B may be responsible for lower cell voltage polarization observed in FIG. 3C. Lower voltage polarization allows functioning of an electrochemical cell at high charge-discharge current rate with negligible cell degradation. It should be understood that LiAsF₆ can be replaced by many other salts such as phosphates (e.g. LiPF₆), borates (e.g. LiBF₄, LiBOB), imides (e.g. LiBETI), triflates (e.g. LiTFSi), chlorates (LiClO₄), imidazoles, (e.g. DCTA or TADC), for example.

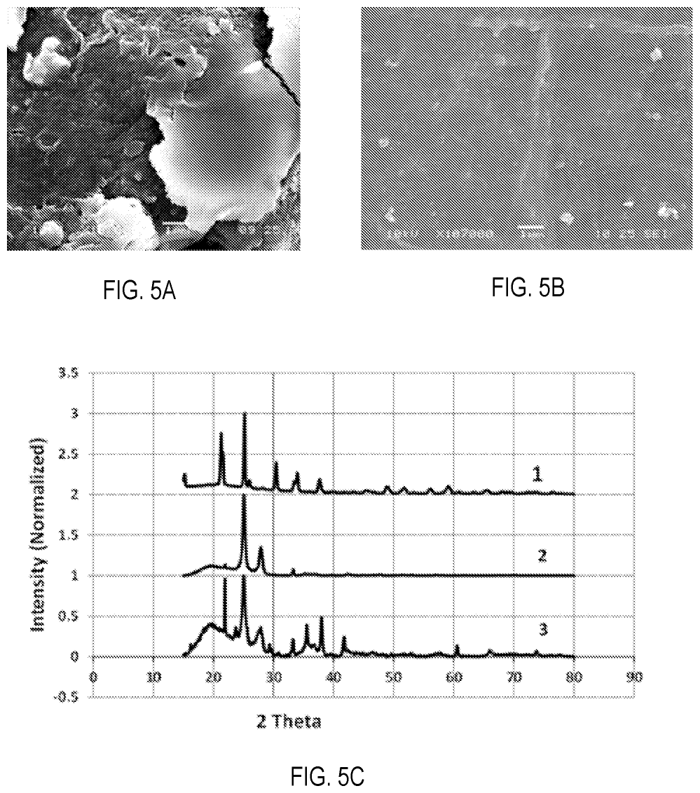

To further differentiate the behavior of PE and LAGP-coated PE separators the surface morphology and XRD after the 300th Li/Li cycle were investigated. FIGS. 5A and 5B show surface morphology of PE and LAGP/PE/LAGP separators, respectively, after these separators were used for 300 cycles in Li/Li symmetrical cells (FIG. 3C).

If compared with surface morphology of pristine PE separator (FIG. 3A) it is clear that during lithium cycling, the PE separators have accumulated significant amount of powder/debris on both sides of PE separator that completely filled the pores of original PE.

The debris is the product of lithium and electrolyte reaction and fragmented lithium dendrites (lithium foil used at the start of cell fabrication was found to be powdery after 300 cycles) formed during cycling. In the case of the hybrid separator, only a small amount of powder (reaction product of lithium and electrolyte or lithium dendrites) was visually observed, most of the lithium remained intact (high usable Li content) in metallic form.

As can be seen in FIG. 5B the surface of used LAGP/PE/LAGP separator is as smooth as the original (FIG. 3B). Preservation of the original surface morphology of functional separator and only partial degradation of lithium foil used can be attributed to the ability of LAGP to prevent dendrite formation, thus prolonging cell cycling life (FIG. 3C) and lowering cell resistance (FIGS. 4A and 4B) as compared to uncoated PE separator.

FIG. 5C shows an XRD pattern of (1) bulk LAGP; (2) used (300 cycles) PE; and (3) used (300 cycles) LAGP/PE/LAGP separator. Characteristic peaks of LAGP are preserved even after 300 cycles, suggesting stability of LAGP material toward long-term and high current Li cycling. Smooth, dense, mechanically-stable, electrochemically-stable and dendrite proof characteristics shown by LAGP will prove beneficial for rechargeable Li batteries.

Additionally, tests were performed to compare the thermal stability of the LAGP ceramic to the PE separator. These tests were performed using a micro combustion calorimeter (MCC) or pyrolysis combustion flow calorimeter (PCFC), which measures the heat release of a material by oxygen consumption calorimetry. Oxygen consumption calorimetery works via Thornton's Rule, which is an empirical relationship that gives the average heat of combustion of oxygen with typical organic (C,H,N,O) gases, liquids, and solids. Specifically, on average 1 g of oxygen gives off 13.1 kJ±0.7 kJ of heat when it reacts with typical organic materials to produce water, carbon dioxide and N₂. Polymers containing a large mole fraction of oxygen (POM, ethylene oxide, etc.) are outside of this standard deviation, as are silicones that consume oxygen to make silica instead of CO₂ and H₂O. Despite these limitations for these particular polymers, oxygen consumption calorimetry serves as a useful technique for assessing the heat release and flammability of many polymeric and organic materials.

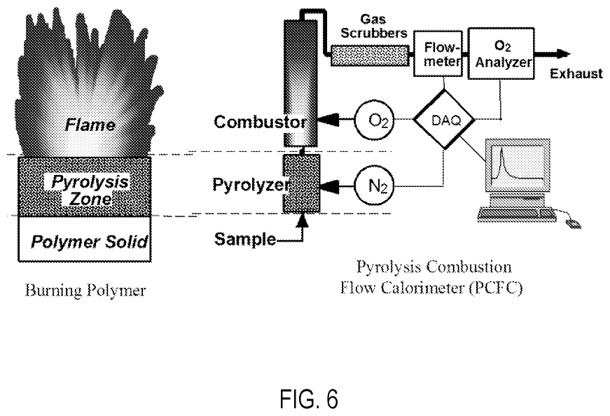

The way the MCC operates is to expose a small sample (5 mg to 50 mg) to very fast heating rates to mimic fire type conditions. The sample can be pyrolyzed under an inert gas (nitrogen) at a fast heating rate, and the gases from the thermally decomposed product are then pushed into a 900° C. combustion furnace where they are mixed with oxygen. Or, the sample can be thermally decomposed under oxidizing conditions (such as air, or a mixture of N₂ and O₂ up to 50%/50%) before going to the combustion furnace. After the gases from the pyrolyzed/thermally decomposed sample are combusted in the 900° C. furnace they are then flowed to an oxygen sensor, and the amount of oxygen consumed during that combustion process equals the heat release for the material at that temperature using Thornton's rule as described above. A general schematic of the instrument function and a picture of the instrument are shown in FIG. 6.

MCC was used to measure the heat release of ceramic coated separators used in potential battery applications. The LAGP ceramic and PE separator samples were tested with the MCC at 1° C./s heating rate under nitrogen from 150° C. to 620° C. using method A of pyrolysis under nitrogen. Each sample was run in triplicate to evaluate reproducibility of the flammability measurements. The LAGP samples were taken to 800° C. with no heat release detected.

Typical results from the MCC focus on heat release measurements and the results that were recorded from each of the materials are shown in Table 1.

TABLE 1
Heat Release Rate Data for Hybrid Electrolyte Separator Materials

| | Char | HRR Peak(s) | HRR Peaks(s) | Total HR |
|---|---|---|---|---|
| Sample | Yield (%) | Value (W/g) | Temp(s) (° C.) | (kJ/g) |
| LAGP | 100.00 | 0 | N/A | 0.0 |
| | 100.00 | 0 | N/A | 0.0 |
| | 100.00 | 0 | N/A | 0.0 |
| PE | 0.06 | 1366 | 490 | 40.5 |
| | 0.11 | 1447 | 487 | 40.8 |
| | 0.05 | 1452 | 489 | 40.9 |
| LAGP + | 10.76 | 964.1 | 493 | 35.0 |
| PE | 7.24 | 1160.3 | 490 | 36.2 |
| | 9.27 | 1067.1 | 487 | 35.2 |

The data in Table 1 provides results of the char yield, HHR peak(s), and total HR for each sample. Char yield is obtained by measuring the sample mass before and after pyrolysis. The higher the char yield, the more carbon/inorganic material left behind. As more carbon is left behind, the total heat release should decrease. HRR Peak(s) are the recorded peak maximum of heat release rate (HRR) found during each experiment. The higher the HRR value, the more heat given off at that event. This value roughly correlates to peak heat release rate that would be obtained by the cone calorimeter. Total HR is the total heat release for the sample, which is the area under the curve(s) for each sample analysis.

Table 1 shows that the LAGP ceramic, by itself, does not pyrolyze or release any flammable gases up to 800° C. The polyethylene (PE) separator, as expected, is highly flammable and burns with high heat release and leaves behind very little residue. Once the LAGP ceramic is added to the PE, heat release is reduced, but there is still a notable amount of heat release given off by the PE as it decomposes.

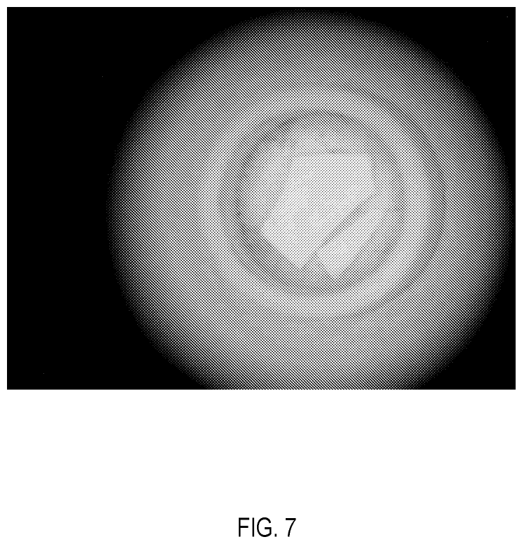

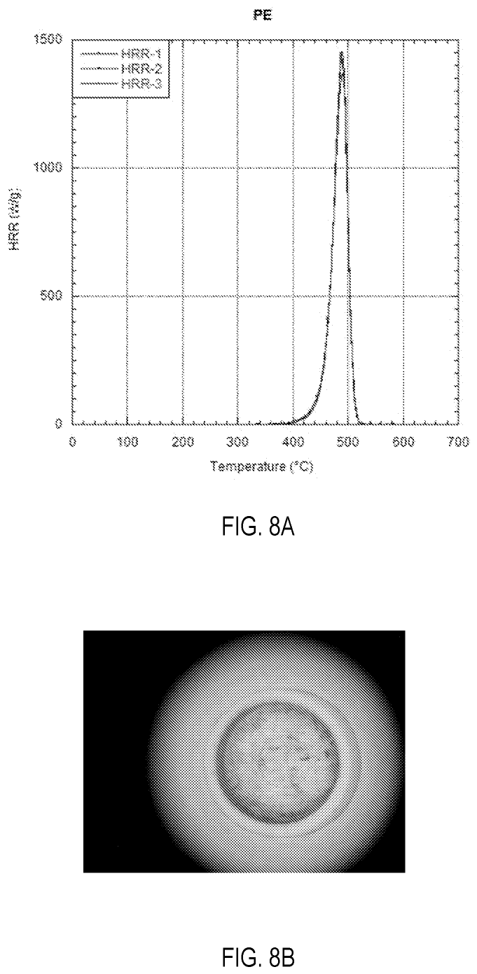

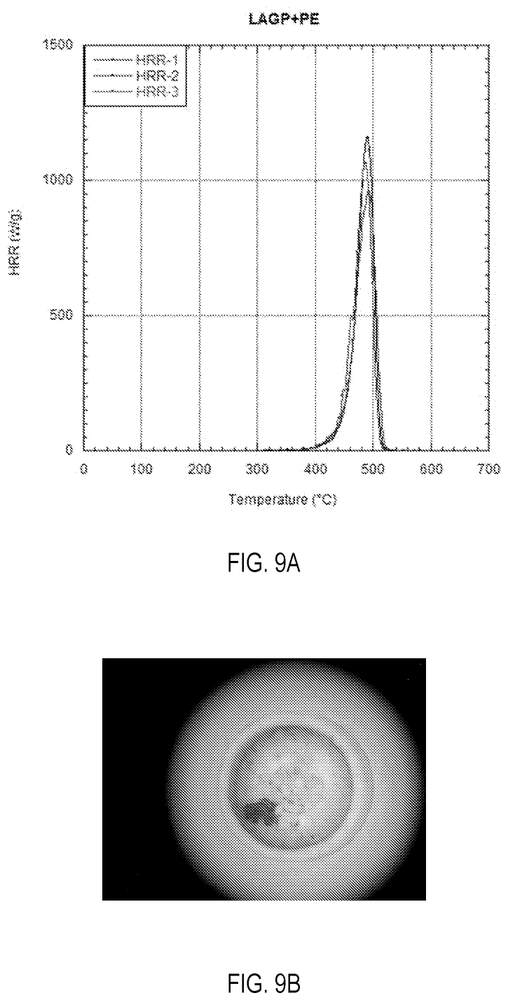

FIGS. 7, 8B, and 9B are photographs of the final chars of the samples. FIGS. 8A and 9A are HRR curves for each of the samples. Also, the HRR curve (other than some scatter in the Peak HRR value) shows good reproducibility. The final char (FIG. 9B) shows that the underlying PE film melts and decomposes, resulting in deformation of the LAGP (compare FIG. 9B to FIG. 7) and a final black char which is probably a combination of carbon residue from the PE and LAGP ceramic.

### Li-Ion Battery

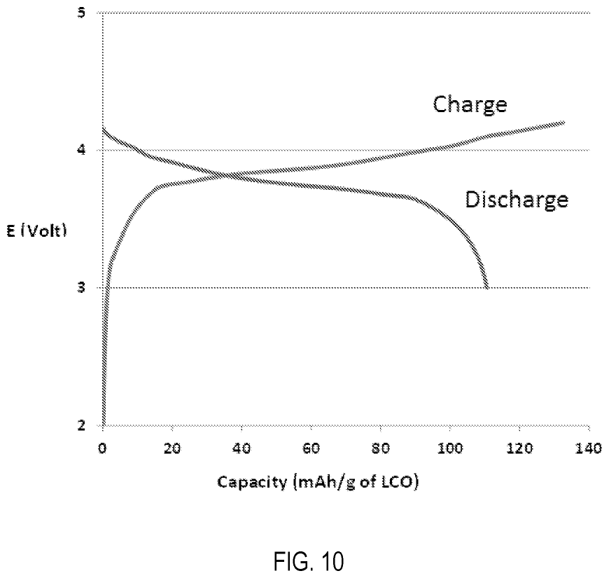

The LAGP coated PE separator was used with a Li-ion battery. A full-cell Li-ion battery cell using LAGP coated PE separator was fabricated with commercially available lithium metal (Li) as anode, lithium cobalt oxide (LiCoO₂, LCO) as cathode, and 1 molar lithium hexafluorophosphate (1M LiPF₆) in ethylene carbonate:dimethyl carbonate:ethylmethyl carbonate (EC:DMC:EMC) as electrolyte solution. The designed cathode capacity is 158 mAh/g. The first cycle charge and discharge characteristics are shown in FIG. 10 with a measured charge and discharge capacity 132.62 mAh and 110.61 mAh. This cell shows a first cycle capacity loss of 22 mAh/g. With an increase in cycle numbers, a Li-ion cell is expected to exhibit comparable charge/discharge performances.

### Li—S Battery

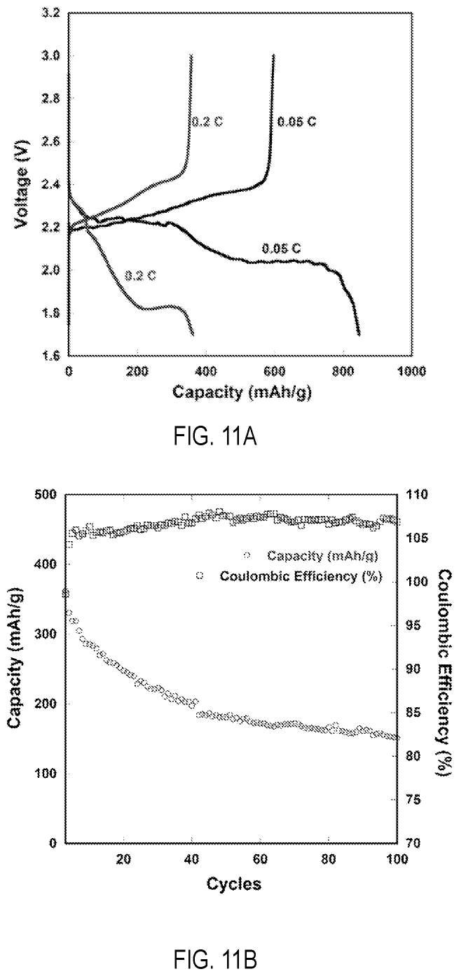

The LAGP coated PE separator was used with a Li—S battery. The cathode was fabricated with 54% S, 18% Super-P carbon, 18% LAGP, 5% CNT, 5% PVDF. Sulfur was hand-milled with Super-P, CNT and LAGP, and melt-diffused into the pores of carbon by gradually ramping up the temperature of the composite to 155° C. and holding it at 155° C. for 12 hours. The final S loading in the cathode was ≈0.8 cm². 14 mm electrodes were punched for making cells. The anode of this cell was made of commercial thick Li foil≈380 μm, 16 mm. The cell used a liquid electrolyte—1M LiTFSI|0.1M LiNO₃|DOL:DME (1:1=v:v). Finally, the separator was made of a LAGP|PE|LAGP separator, or commercial PE separator. FIGS. 11A and 11B show that LAGP coating of PE separator (commercial) enhances battery performance.

In summary, and as described above, an EB-PVD technique was used to fabricate ceramic/polymer/ceramic (LAGP/PE/LAGP) hybrid separator for rechargeable LIBs and Li batteries. It was found that the application of a ceramic electrolyte (LAGP) layer on traditional PE separator soaked in 1-M LiAsF₆ liquid electrolyte combined the best attributes of traditional PE separator and solid inorganic electrolytes. The synergistic behavior of hybrid separator resulted in a high mechanical stability/flexibility, increased liquid uptake, high ion conduction, reduced cell voltage polarization, no lithium dendrite formation and increased usable lithium content as compared to the state-of-the-art PE separator used in LIBs. Optimization of thickness and density of LAGP or other LISICON ceramic electrolytes on PE or similar polymer separator along with post deposition annealing, will result in a functional separator that can be used to prolong life cycle and power capability of present LIBs. Thickness and density optimization of LAGP or LATP on polymer separators and their use in full Li battery (Li—S, Li—O₂ and Li anode-based LIB) cells are expected to further improve performance.

Unless otherwise defined, all technical and scientific terms used herein have the same meaning as commonly understood by one of ordinary skill in the art to which the claimed subject matter belongs. The terminology used in the description herein is for describing particular embodiments only and is not intended to be limiting. As used in the specification and appended claims, the singular forms “a,” “an,” and “the” are intended to include the plural forms as well, unless the context clearly indicates otherwise.

It is noted that terms like “preferably,” “commonly,” and “typically” are not utilized herein to limit the scope of the appended claims or to imply that certain features are critical, essential, or even important to the structure or function of the claimed subject matter. Rather, these terms are merely intended to highlight alternative or additional features that may or may not be utilized in a particular embodiment.

What is claimed is:

1. A lithium-ion battery comprising:
an anode;
a cathode; and
a hybrid electrolyte separator disposed between the anode and the cathode,
wherein:
the hybrid electrolyte separator comprises a polymer membrane, a first ceramic coating between the polymer membrane and the anode, and a second ceramic coating between the polymer membrane and the cathode.

2. The lithium-ion battery of claim 1, wherein:
the polymer membrane is chosen from polyethylene, polyimides, or polyamides;
the first ceramic coating and the second ceramic coating are lithium-ion conductive materials independently chosen from lithium aluminum germanium phosphate (LAGP), lithium aluminum titanium phosphate (LATP), LiSICON, LiPON, perovskites, garnet-type ceramics, or phthalocyanines.

3. The lithium-ion battery of claim 1, wherein:
the polymer membrane comprises polyethylene;
the first ceramic coating and the second ceramic coating comprise lithium aluminum germanium phosphate (LAGP).

4. The lithium-ion battery of claim 3, wherein the first ceramic coating and the second ceramic coating are coated directly onto opposing surfaces of the polymer membrane.

5. The lithium-ion battery of claim 3, wherein the LAGP has an empirical formula 19.75 Li₂O·6.17 Al₂O₃·37.04 GeO₂·37.04 P₂O₅.

6. The lithium-ion battery of claim 3, wherein the anode, the cathode, and the hybrid electrolyte separator are disposed in a liquid electrolyte.

7. The lithium-ion battery of claim 6, wherein the liquid electrolyte comprises LiPF₆ in a solvent chosen from ethylene carbonate, dimethyl carbonate, ethylmethyl carbonate and mixtures thereof.

8. The lithium-ion battery of claim 2, wherein the lithium-ion battery is configured as a Li-oxygen (Li—O₂) cell, a Li-Phthalocyanine (Li-Ph) cell, a redox flow battery, a supercapacitor, or a hybrid battery-capacitor.

9. The lithium-ion battery of claim 2, wherein the anode is lithium metal and the cathode is LiCoO₂.

10. The lithium-ion battery of claim 2, wherein the anode is lithium metal and the cathode comprises sulfur, LAGP, carbon nanotubes, and PVDF.

11. A method for preparing a lithium battery, the method comprising:
depositing a first ceramic coating onto a first surface of a polymer membrane;
depositing a second ceramic coating onto a second surface of the polymer membrane opposite the first surface;
assembling the polymer membrane coated with the first ceramic coating and the second ceramic coating between an anode and a cathode such that the first ceramic coating faces the anode and the second ceramic coating faces the cathode, the anode comprising lithium metal.

12. The method of claim 11, wherein both depositing the first ceramic coating and depositing the second ceramic coating comprise a coating process chosen from electron-beam physical vapor deposition, atomic layer deposition, sputtering, laser ablation, chemical vapor deposition, or combinations thereof.

13. The method of claim 11, wherein both depositing the first ceramic coating and depositing the second ceramic coating comprise electron-beam physical vapor deposition.

14. The method of claim 11, wherein:
the polymer membrane is chosen from polyethylene, polyimides, or polyamides;
the first ceramic coating and the second ceramic coating are lithium-ion conductive materials independently chosen from lithium aluminum germanium phosphate (LAGP), LiSICON, LiPON, lithium aluminum titanium phosphate (LATP), perovskites, garnet-type ceramics, or phthalocyanines.

15. The method of claim 11, wherein:
the polymer membrane comprises polyethylene;
the first ceramic coating and the second ceramic coating comprise lithium aluminum germanium phosphate (LAGP).

16. The method of claim 11, wherein the first ceramic coating and the second ceramic coating are deposited directly onto opposing surfaces of the polymer membrane.

17. The method of claim 11, wherein the cathode is LiCoO₂.

18. The method of claim 11, wherein the cathode comprises sulfur, LAGP, carbon nanotubes, and PVDF.

19. A hybrid electrolyte separator for a lithium-ion battery, the hybrid electrolyte separator comprising:
a polymer membrane;
a first ceramic coating on a first surface of the polymer membrane; and
a second ceramic coating on a second surface of the polymer membrane opposite the first surface,
wherein:
the polymer membrane is chosen from polyethylene, polyimides, or polyamides; and
the first ceramic coating and the second ceramic coating are lithium-ion conductive materials independently chosen from lithium aluminum germanium phosphate (LAGP), LiSICON, LiPON, perovskites, garnet-type ceramics, or phthalocyanines.

20. The hybrid electrolyte separator or claim 19, wherein the polymer membrane is polyethylene and at least one of the first ceramic coating and the second ceramic coating is lithium aluminum germanium phosphate (LAGP).
